(19) United States
(12) Patent Application Publication
(10) Pub. No.: US 2025/0325944 A1
(43) Pub. Date: Oct. 23, 2025

(54) ZONED THREE-WAY CONVERSION CATALYSTS COMPRISING PLATINUM, PALLADIUM, AND RHODIUM

(71) Applicant: BASF CORPORATION, Florham Park, NJ (US)

(72) Inventors: Yipeng SUN, Iselin, NJ (US); Stephen C JOHNSON, Wixom, MI (US); Krishnan S PILLAI, Huntsville, AL (US); Brian T JONES, Huntsville, AL (US); Yuejin LI, Iselin, NJ (US); Xiaolai ZHENG, Iselin, NJ (US); Chunxin JI, Iselin, NJ (US); Pramod RAVINDRAN, Wixom, MI (US); Pascaline TRAN, Iselin, NJ (US)

(21) Appl. No.: 18/870,191

(22) PCT Filed: Jun. 1, 2023
(86) PCT No.: PCT/EP2023/064658

§ 371 Date: Nov. 27, 2024

(30) Foreign Application Priority Data
Jun. 2, 2022 (EP) 22176891.4

(51) Int. Cl. B01D 53/94; B01J 23/42; B01J 23/44; B01J 23/46; B01J 23/58; B01J 23/63

(52) U.S. Cl. CPC B01D 53/9472; B01J 23/42; B01J 23/44; B01J 23/464; B01J 23/58; B01J 23/63; B01D 2255/908; B01D 2257/404; B01D 2257/502; B01D 2257/702

(57) ABSTRACT

A catalytic article comprising a substrate; a first zone coated with a first catalytic layer comprising platinum supported on ceria-zirconia mixed oxide or ceria-alumina composite or both; and rhodium supported on ceria-zirconia mixed oxide or ceria-alumina composite or both; and a second zone coated with a second catalytic layer comprising palladium supported on ceria-zirconia mixed oxide, alumina, ceria-aluminia or any combination thereof; and rhodium supported on ceria-zirconia mixed oxide alumina, ceria-alumina composite or any combination thereof, wherein the first zone occupies a flow-in end portion of the substrate and the second zone occupies a flow-out end portion of the substrate. The present invention also provides a process for the preparation of the catalytic article, an exhaust gas treatment system for internal combustion engines comprising the catalytic article according to the present invention, and a method of treating a gaseous exhaust stream.

### FIELD OF THE INVENTION

The presently claimed invention relates to a catalyst useful for the treatment of exhaust gases to reduce contaminants contained therein. Particularly, the presently claimed invention relates to a catalytic article comprising zoned three-way conversion (TWC) catalysts comprising platinum, palladium, and rhodium.

### BACKGROUND OF THE INVENTION

Three-way conversion (TWC) catalysts are well known for their catalytic activity of reducing pollutants such as NO, CO and HC using platinum group metals (PGM). A conventional TWC catalyst uses Pd and Rh as active catalytic components. In consideration of the current PGM market price, to replace a part of more expensive palladium (Pd) with less expensive platinum (Pt) in TWC catalysts would help catalytic converter manufacturers and automobile manufacturers to reduce the cost significantly. Accordingly, the current invention is focussed on developing a highly active, zoned TWC catalyst comprising platinum, palladium, and rhodium as the PGM components. It is known that the replacement of a substantial amount of Pd with Pt (e.g., 50%) in TWC catalysts usually leads to lower catalytic activity probably due to relatively low thermal stability of Pt towards high temperature aging, especially under harsh TWC operation conditions.

Accordingly, it is desired to design a Pt/Pd/Rh-based TWC catalyst in an appropriate architecture to improve the emission control efficiency.

### OBJECT OF THE INVENTION

The object of the present invention is to improve cumulative non-methane hydrocarbon (NMHC) and NOx performance of the three-way conversion (TWC) catalysts comprising Pt, Pd and Rh as active platinum group metal (PGM) components.

### SUMMARY OF THE INVENTION

The present invention provides a catalytic article comprising a) a substrate; b) a first zone coated with a first catalytic layer; and c) a second zone coated with a second catalytic layer, wherein the first catalytic layer comprises platinum supported on ceria-zirconia mixed oxide or ceria-alumina composite or both; and rhodium supported on ceria-zirconia mixed oxide, ceria-alumina composite, alumina or any combination thereof, wherein the second catalytic layer comprises palladium supported on ceria-zirconia mixed oxide, alumina, ceria-alumina composite, or any combination thereof; and rhodium supported on ceria-zirconia mixed oxide, alumina, ceria-alumina composite, or any combination thereof, wherein the first zone occupies a flow-in end portion of the substrate and the second zone occupies a flow-out end portion of the substrate.

The present invention also provides a process for the preparation of the catalytic article, wherein said process comprises preparing a first catalytic layer slurry comprising platinum supported on ceria-zirconia mixed oxide or ceria-alumina composite or both; and rhodium supported on ceria-zirconia mixed oxide, ceria-alumina composite, alumina or any combination thereof; preparing a second catalytic layer slurry comprising palladium supported on ceria-zirconia mixed oxide, alumina, ceria-alumina composite or any combination thereof; and rhodium supported on ceria-zirconia mixed oxide, alumina, ceria-alumina composite or any combination thereof; coating the first catalytic layer slurry on the flow-in end portion of the substrate to obtain a first zone; coating the second catalytic layer slurry on the flow-out end portion of the substrate to obtain a second zone; subjecting the substrate to calcination at a temperature ranging from 400 to 700° C., wherein the step of preparing the slurry comprises a technique selected from incipient wetness impregnation, incipient wetness co-impregnation, and post-addition.

The present invention further provides an exhaust gas treatment system for internal combustion engines comprising the catalytic article according to the presently claimed invention. The present invention furthermore provides a method of treating a gaseous exhaust stream comprising hydrocarbons, carbon monoxide, and nitrogen oxide which comprises contacting the exhaust stream with the catalytic article or the exhaust gas treatment system according to the presently claimed invention.

### BRIEF DESCRIPTION OF THE DRAWINGS

In order to provide an understanding of the embodiments of the invention, reference is made to the appended drawings, which are not necessarily drawn to scale, and in which reference numerals refer to components of exemplary embodiments of the invention. The drawings are exemplary only and should not be construed as limiting the invention. The above and other features of the presently claimed invention, their nature, and various advantages will become more apparent upon consideration of the following detailed description, taken in conjunction with the accompanying drawings:

FIG. 1A illustrate the two-layered zoned catalytic articles (comparative catalyst A and B).

FIG. 1B illustrate the single-layered zoned catalytic article (comparative catalyst C).

FIG. 1C illustrates the single-layered zoned catalytic articles according to the inventive catalyst D of the present invention.

FIG. 1D illustrates the single-layered zoned catalytic articles according to the inventive catalyst E of the present invention.

FIG. 1E illustrates the zoned catalytic articles with PGM-free overcoat according to the inventive catalyst F of the present invention.

FIG. 2 illustrates engine out and catalyst bed temperature of the catalytic articles.

FIG. 3 illustrates comparative cumulative non-methane hydrocarbon (NMHC) and NOx tail pipe emissions under the FTP-75 test cycle using the catalytic articles.

FIG. 4A is a perspective view of a honeycomb-type substrate carrier which may comprise the catalyst composition in accordance with one embodiment of the presently claimed invention.

FIG. 4B is a partial cross-section view enlarged relative to FIG. 4A and taken along a plane parallel to the end faces of the substrate carrier of FIG. 4A, which shows an enlarged view of a plurality of the gas flow passages shown in FIG. 4A.

FIG. 5 is a cutaway view of a section enlarged relative to FIG. 4A, wherein the honeycomb-type substrate in FIG. 4A represents a wall flow filter substrate monolith.

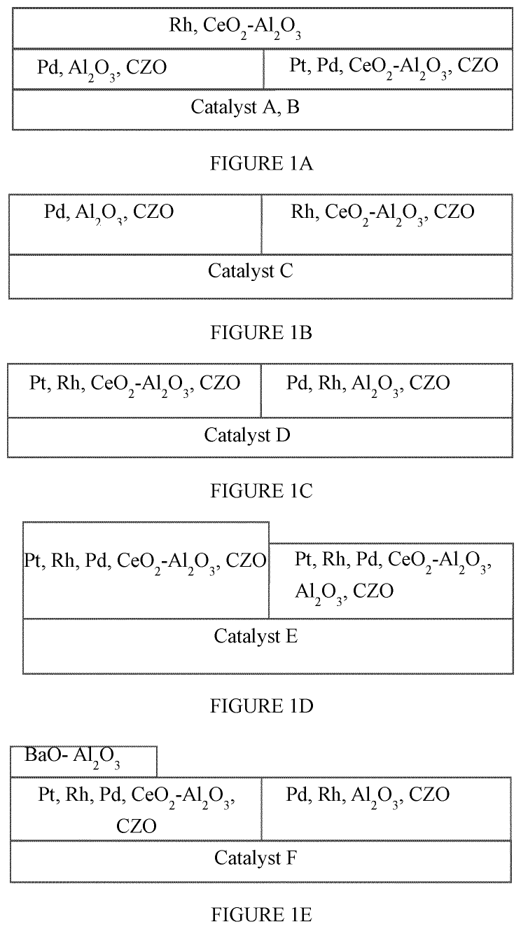

### DETAILED DESCRIPTION

The presently claimed invention will be described more fully hereafter. The presently claimed invention may be embodied in many different forms and should not be construed as limited to the embodiments set forth herein; rather, these embodiments are provided so that this presently claimed invention will be thorough and complete, and will fully convey the scope of the invention to those skilled in the art. No language in the specification should be construed as indicating any non-claimed element as essential to the practice of the disclosed materials and methods.

All methods described herein can be performed in any suitable order unless otherwise indicated herein or otherwise clearly contradicted by context. The use of any and all examples, or exemplary language (e.g., “such as”) provided herein, is intended merely to better illustrate the materials and methods and does not pose a limitation on the scope unless otherwise claimed.

### Definitions

The use of the terms “a”, “an”, “the”, and similar referents in the context of describing the materials and methods discussed herein (especially in the context of the following claims) are to be construed to cover both the singular and the plural, unless otherwise indicated herein or clearly contradicted by context.

Recitation of ranges of values herein are merely intended to serve as a shorthand method of referring individually to each separate value falling within the range, unless otherwise indicated herein, and each separate value is incorporated into the specification as if it were individually recited herein.

In the context of the present invention the term “washcoat” is interchangeably used for “first catalytic layer and/or the second catalytic layer” which forms a first zone and respectively a second zone on a part of the substrate. As used herein, the term “washcoat” has its usual meaning in the art of a thin, adherent coating of a catalytic or other material applied to a substrate material. Generally, a washcoat is formed by preparing a slurry containing a certain solid content (e.g., 15-60% by weight) of particles in a liquid vehicle, which is then coated onto a substrate and dried to provide a washcoat layer.

The term “overcoat” is interchangeably used for “top coat”, or “top washcoat”, or “second layer” and the overcoat is deposited at least on a part of the first zone.

In the context of the present invention the term “first zone” is interchangeably used for “inlet zone” or “front zone” and the term “second zone” is interchangeably used for “outlet zone” or “rear zone” The terms “first zone” and “second zone” also describe the relative positioning of the catalytic article in flow direction, respectively the relative positing of the catalytic article when placed in an exhaust gas treatment system. The first zone would be positioned upstream, whereas the second zone would be positioned downstream. The first zone covers at least some portion of the substrate from the inlet of the substrate, whereas the second zone covers at least some portion of the substrate from the outlet of the substrate. The inlet of the substrate is a first end which is capable to receive the flow of an engine exhaust gas stream from an engine (flow-in end portion), whereas the outlet of the substrate is a second end from which a treated exhaust gas stream exit (flow-out end portion).

The term “three-way conversion catalyst” or TWC catalyst refers to a catalyst that simultaneously promotes a) reduction of nitrogen oxides to nitrogen and oxygen; b) oxidation of carbon monoxide to carbon dioxide; and c) oxidation of unburnt hydrocarbons to carbon dioxide and water.

The term “NOx” refers to nitrogen oxide compounds, such as NO and/or NO₂.

As used herein, the term “stream” broadly refers to any combination of flowing gas that may contain solid or liquid particulate matters.

As used herein, the terms “upstream” and “downstream” refer to relative directions according to the flow of an engine exhaust gas stream from an engine towards a tailpipe, with the engine in an upstream location and the tailpipe and any pollution abatement articles such as filters and catalysts being downstream from the engine.

In the context of the present invention, the amount of platinum group metal/s such as platinum/palladium/rhodium, and/or support material such as ceria-zirconia mixed oxide, ceria-alumina composite, alumina etc is calculated as weight %, based on the total weight of the washcoats incl. optional top washcoats present on the substrate. i.e., the amount is calculated without considering the substrate amount, though substrate is part of the catalytic article.

The present invention focussed on addressing low HC activity associated with a conventional Pt/Pd/Rh trimetal TWC technology. Accordingly, a Pt/Pd/Rh-based TWC catalytic article with a zoned architecture is designed. The invention designs features Pt/Rh synergy in the front zone to improve HC performance, low wash coat loading to accelerate warm up during cold start, and PGM free overcoat to improve phosphorus poisoning resistance.

### Catalytic Article

The present invention in a first aspect provides a article comprising a) a substrate;
b) a first zone coated with a first catalytic layer; and c) a second zone coated with a second catalytic layer,
wherein the first catalytic layer comprises platinum supported on ceria-zirconia mixed oxide or ceria-alumina composite or both; and rhodium supported on ceria-zirconia mixed oxide, ceria-alumina composite, alumina or any combination thereof,
wherein the second catalytic layer comprises palladium supported on ceria-zirconia mixed oxide, alumina, ceria-alumina composite or any combination thereof; and rhodium supported on ceria-zirconia mixed oxide, alumina, ceria-alumina composite or any combination thereof,
wherein the first zone occupies a flow-in end portion of the substrate and the second zone occupies a flow-out end portion of the substrate.

The total loading of the first catalytic layer and the second catalytic layer divided by substrate volume is less than 3.2 gram per cubic inch.

### Amount of Platinum Group Metals

The amount of platinum in the first catalytic layer and the second catalytic layer is preferably in the range of 0.02 to 3.0 wt. %, based on the total weight of the first catalytic layer and the second catalytic layer. More preferably, the amount of platinum in the first catalytic layer and the second catalytic layer is in the range of 0.05 to 2.0 wt. %, based on the total weight of the first catalytic layer and the second catalytic layer.

The amount of palladium in the first catalytic layer and the second catalytic layer is preferably in the range of 0.02 to 5.0 wt. %, based on the total weight of the first catalytic layer and the second catalytic layer. More preferably, the amount of palladium in the first catalytic layer and the second catalytic layer is in the range of 0.05 to 3.0 wt. %, based on the total weight of the first catalytic layer and the second catalytic layer.

The amount of rhodium in the first catalytic layer and the second catalytic layer is preferably in the range of 0.01 to 1.0 wt. %, based on the total weight of the first catalytic layer and the second catalytic layer. More preferably, the amount of rhodium in the first catalytic layer and the second catalytic layer is in the range of 0.05 to 0.5 wt. %, based on the total weight of the first catalytic layer and the second catalytic layer.

The weight proportion of palladium to platinum in the first catalytic layer and the second catalytic layer is preferably 4:1 to 1:4. More preferably, the weight proportion of palladium to platinum in the first catalytic layer and the second catalytic layer is 3:1 to 1:3.

Preferably, the weight proportion rhodium supported on ceria-zirconia mixed oxide or ceria-alumina composite or both in the first catalytic layer to rhodium supported on ceria-zirconia mixed oxide, alumina, ceria-alumina composite or any combination thereof in the second catalytic layer is in the range of 1.5:1 to 4:1.

Preferably, the amount of platinum in the first catalytic layer is 0.02 to 3.0 wt. %, based on the total weight of the first catalytic layer. More preferably, the amount of platinum in the first catalytic layer is 0.02 to 2.5 wt. %, based on the total weight of the first catalytic layer. Even more preferably, the amount of platinum in the first catalytic layer is 0.05 to 2.0 wt. %, based on the total weight of the first catalytic layer.

Preferably, the amount of platinum supported on ceria-zirconia mixed oxide or ceria-alumina composite or both in the first catalytic layer is 60 to 100 wt. %, based on the total weight of platinum in the first and the second catalytic layer. More preferably, the amount of platinum supported on ceria-zirconia mixed oxide or ceria-alumina composite or both in the first catalytic layer is 70 to 100 wt. %, based on the total weight of platinum in the first and the second catalytic layer. Most preferably, the amount of platinum supported on ceria-zirconia mixed oxide or ceria-alumina composite or both in the first catalytic layer is 80 to 100 wt. %, based on the total weight of platinum in the first and the second catalytic layer.

Preferably, the total amount of rhodium in the first catalytic layer is 0.01 to 1.0 wt. %, based on the total weight of the first catalytic layer. More preferably, the total amount of rhodium in the first catalytic layer is 0.01 to 0.5 wt. %, based on the total weight of the first catalytic layer.

Preferably, the amount of palladium is in the range of 0.02 to 5.0 wt. %, based on the total weight of the second catalytic layer. More preferably, the amount of palladium is in the range of 0.02 to 4.0 wt. %, based on the total weight of the second catalytic layer.

Preferably, the amount of palladium supported on the ceria-zirconia mixed oxide, alumina, ceria-alumina composite or any combination thereof in the second catalytic layer is preferably 50 to 100 wt. %, based on the total weight of palladium in the first catalytic layer and the second catalytic layer. More preferably, the amount of palladium supported on the ceria-zirconia mixed oxide, alumina, ceria-alumina composite or any combination thereof in the second catalytic layer is 60 to 100 wt. %, based on the total weight of palladium in the first catalytic layer and the second catalytic layer. Most preferably, the amount of palladium supported on the ceria-zirconia mixed oxide, alumina, ceria-alumina composite or any combination thereof in the second catalytic layer is 75 to 100 wt. %, based on the total weight of palladium in the first catalytic layer and the second catalytic layer.

Preferably, the amount of rhodium supported on the ceria-zirconia mixed oxide, alumina, ceria-alumina composite or any combination thereof in the second catalytic layer is preferably 0 to 50 wt. %, based on the total weight of rhodium in the first catalytic layer and the second catalytic layer. More preferably, the amount of rhodium supported on the ceria-zirconia mixed oxide, alumina, ceria-alumina composite or any combination thereof in the second catalytic layer is 0 to 25 wt. %, based on the total weight of rhodium in the first catalytic layer and the second catalytic layer.

### Support Materials

A “support” in a catalytic material or catalyst composition or catalyst washcoat refers to a material such as alumina, ceria-alumina composite, ceria-zirconia mixed oxide etc. that receives metals (e.g., PGMs), stabilizers, promoters, binders, and the like through precipitation, association, dispersion, impregnation, or other suitable methods.

The term “supported” throughout this application has the general meaning as in the field of heterogenous catalysis. In general, the term “supported” refers to an affixed catalytically active species or its respective precursor to a support material. The support material may be inert or participate in the catalytic reaction. Commonly supported catalysts are prepared by impregnation methods or co-precipitation methods and optional subsequent calcination.

### Ceria-Alumina Composite

Ceria-alumina composite is a composite in which CeO₂ is distributed on the surface of alumina and/or in the bulk as particles and/or nano clusters. Each oxide may have its distinct chemical and solid physical state. The surface CeO₂ modification of alumina can be in the form of discrete moieties (particles or clusters) or in the form of a layer of ceria that covers the surface of alumina partially or completely.

Preferably, the amount of the ceria-alumina composite present in the first catalytic layer and the second catalytic layer is in the range of 5.0 to 80 wt. %, based on the total weight of the first catalytic layer and the second catalytic layer. More preferably, the amount of the ceria-alumina composite present in the first catalytic layer and the second catalytic layer is in the range of 10 to 60 wt. %, based on the total weight of the first catalytic layer and the second catalytic layer. More preferably, the amount of the ceria-alumina composite present in the first catalytic layer and the second catalytic layer is in the range of 15 to 40 wt. %, based on the total weight of the first catalytic layer and the second catalytic layer.

The amount of CeO₂ (cerium oxide) in the ceria-alumina composite present in the first or second catalytic layer is preferably 1.0 to 60 wt. %, based on the total weight of the ceria-alumina composite in the respective catalytic layer. More preferably, the CeO₂ in the ceria-alumina composite present in the first or second catalytic layer is 5.0 to 50 wt. %, based on the total weight of the ceria-alumina composite in the respective catalytic layer. Even more preferably, the CeO₂ in the ceria-alumina composite present in the first or second catalytic layer is 5.0 to 30 wt. %, based on the total weight of the ceria-alumina composite in the respective catalytic layer. And even more preferably, the CeO₂ in the ceria-alumina composite present in the first or second catalytic layer is 8.0 to 20 wt. %, based on the total weight of the ceria-alumina composite in the respective catalytic layer.

The amount of Al₂O₃ (aluminium oxide) in the ceria-alumina composite present in the first or second catalytic layer is preferably 40 to 99 wt. % based on the total weight of the ceria-alumina composite in the respective catalytic layer. More preferably, the Al₂O₃ in the ceria-alumina composite present in the first or second catalytic layer is 50 to 95 wt. % based on the total weight of the ceria-alumina composite in the respective catalytic layer. Even more preferably, the Al₂O₃ in the ceria-alumina composite present in the first or second catalytic layer is 70 to 95 wt. %

based on the total weight of the ceria-alumina composite in the respective catalytic layer. Most preferably, the Al₂O₃ in the ceria-alumina composite present in the first or second catalytic layer is 80 to 92 wt. %, based on the total weight of the ceria-alumina composite in the first catalytic layer.

Preferably, the average particle size of ceria in the ceria-alumina composite is less than 200 nm. More preferably, the particles size is in the range of 5.0 nm to 50 nm. The particle size is determined by transition electron microscopy.

The ceria-alumina composite present in the first or second catalytic layer may comprise a dopant selected from zirconia, lanthana, titania, hafnia, magnesia, calcia, strontian, baria or any combination thereof. The total amount of dopant in the ceria-alumina composite is preferably in the range of 0.001 to 15 wt. % based on the total weight of the ceria-alumina composite in the respective catalytic layer.

The ceria-alumina composite can be made by methods known to the person skilled in the art like co-precipitation or surface modification. In these methods, a suitable cerium containing precursor is brought into contact with a suitable aluminium containing precursor and the so obtained mixture is then transformed into the ceria-alumina composite. Suitable cerium containing precursors are for example water soluble cerium salts and colloidal ceria suspension. Ceria-alumina can also be prepared by the atomic layer deposition method, where a ceria compound selectively reacts with an alumina surface, which after calcination forms ceria on the alumina surface. This deposition/calcination step can be repeated until a layer of desired thickness is reached. Suitable aluminium containing precursors are for example aluminium oxides like gibbsite, boehmite gamma alumina, delta alumina or theta alumina or their combinations. Transformation of the so obtained mixture into the ceria-alumina composite can then be achieved by a calcinations step of the mixture.

### Ceria-Zirconia Mixed Oxide (CZO)

The term of complex metal oxide refers to a mixed metal oxide that contains oxygen anions and at least two different metal cations. In the ceria-zirconia mixed oxide, cerium cations, zirconium cations are distributed within the oxide lattice structure. The terms “complex oxide” and “mixed oxide” can be used interchangeably. As the metal cations are distributed within the oxide lattice structure, these structures are also commonly referred to as solid solutions. Preferably, the amount of the ceria-zirconia mixed oxide present in the first catalytic layer and the second catalytic layer is 20 to 80 wt. %, based on the total weight of the first catalytic layer and the second catalytic layer. More preferably, the amount of ceria-zirconia mixed oxide present in the first catalytic layer and the second catalytic layer is in the range of 30 to 70 wt. %, based on the total weight of the first catalytic layer and the second catalytic layer. Most preferably, the amount of ceria-zirconia mixed oxide present in the first catalytic layer and the second catalytic layer is in the range of 40 to 60 wt. %, based on the total weight of the first catalytic layer and the second catalytic layer.

Preferably, ceria (calculated as CeO₂) of the ceria-zirconia mixed oxide present in the first or second layer is present in an amount of 10 to 60 wt. %, based on the total weight of the ceria-zirconia mixed oxide present in the respective layer and zirconia (calculated as ZrO₂) of the ceria-zirconia mixed oxide present in the first or second layer is present in an amount of 40 to 90 wt. %, based on the total weight of the ceria-zirconia mixed oxide present in the respective layer.

More preferably, ceria (calculated as CeO₂) of the ceria-zirconia mixed oxide present in the first or second layer is present in an amount of 20 to 50 wt. %, based on the total weight of the ceria-zirconia mixed oxide in the respective catalytic layer and zirconia (calculated as ZrO₂) of the ceria-zirconia mixed oxide present in the first or second layer is present in an amount of 50 to 80 wt. %, based on the total weight of the ceria-zirconia mixed oxide in the respective catalytic layer.

Even more preferably, ceria (calculated as CeO₂) of the ceria-zirconia mixed oxide present in the first or second layer is present in an amount of 30 to 50 wt. %, based on the total weight of the ceria-zirconia mixed oxide in the respective catalytic layer and zirconia (calculated as ZrO₂) of the ceria-zirconia mixed oxide present in the first or second layer is present in an amount of 50 to 70 wt. %, based on the total weight of the ceria-zirconia mixed oxide in the respective catalytic layer.

The ceria-zirconia mixed oxide serves as oxygen storage component. The term “oxygen storage component” (OSC) refers to an entity that has a multi-valence state and can actively react with reductants such as carbon monoxide (CO) and/or hydrogen under reduction conditions and then react with oxidants such as oxygen or nitrogen oxides under oxidative conditions.

In a preferred embodiment, the ceria-zirconia mixed oxide present in the first or second layer comprises a dopant selected from lanthana, titania, hafnia, magnesia, calcia, strontia, baria, yttrium, hafnium, praseodymium, neodymium, or any combinations thereof. The dopant metal may be incorporated in a cationic form into the crystal structure of the complex metal oxide, may be deposited in an oxidic form on the surface of the complex metal oxide, or may be present in the oxidic form as a blend of mixtures of both dopants and complex metal oxide on a micro-scale, so to say in a composite form with the complex metal oxide. Preferably, the dopant(s) are comprised in an amount of 1.0 to 20 wt. %, or more preferably in an amount of 5.0 to 15 wt. %, based on the total weight of the ceria-zirconia mixed oxide present in the respective layer.

### Alumina

Alumina present in the first catalytic layer and the second catalytic layer is preferably gamma alumina or activated alumina. It typically exhibits a BET surface area of fresh material in excess of 60 square meters per gram (“m2/g”), often up to about 200 m²/g or higher. Activated alumina is usually a mixture of the gamma and delta phases of alumina, but may also contain substantial amounts of eta, kappa and theta alumina phases. Preferably, the activated alumina is high bulk density gamma-alumina, low or medium bulk density large pore gamma-alumina, low bulk density large pore boehmite or gamma-alumina.

Preferably, the amount of alumina present in the first catalytic layer and the second catalytic layer is in the range of 1.0 to 40 wt. %, based on the total weight of the first catalytic layer and the second catalytic layer. More preferably, the amount of the alumina present in the first catalytic layer and the second catalytic layer is in the range of 5.0 to 30 wt. %, based on the total weight of the first catalytic layer and the second catalytic layer. Most preferably, the amount of alumina present in the first catalytic layer and the second catalytic layer is in the range of 5.0 to 20 wt. %, based on the total weight of the first catalytic layer and the second catalytic layer. Alumina present in the first catalytic layer and the second catalytic layer is preferably doped with a dopant selected from barium, lanthana, zirconia, neodymian, yttria, ceria or titania, wherein the amount of the dopant is preferably 1.0 to 30 wt. % based on the total weight of alumina and dopant present in the first catalytic layer and the second catalytic layer. More preferably, alumina doped with dopant/s is selected from lanthana-alumina, titania-alumina, ceria-zirconia-alumina, zirconia-alumina, lanthana-zirconia-alumina, baria-alumina, baria-lanthana-alumina, baria-lanthana-neodymia-alumina, or any combination thereof.

### Substrate

The substrate of the catalytic article of the presently claimed invention may be constructed of any material typically used for preparing automotive catalysts. In a preferred embodiment, the substrate is a ceramic substrate, metal substrate, ceramic foam substrate, polymer foam substrate or a woven fiber substrate. In a more preferred embodiment, the substrate is a ceramic or a metal monolithic honeycomb structure.

The substrate provides a plurality of wall surfaces upon which the catalytic layer/s or washcoat described herein above are applied and adhered, thereby acting as a carrier for the catalytic material.

Preferable metallic substrates include heat resistant metals and metal alloys such as titanium and stainless steel as well as other alloys in which iron is a substantial or major component. Such alloys may contain one or more nickel, chromium, and/or aluminium, and the total amount of these metals may advantageously comprise at least 15 wt. % of the alloy. e.g., 10-25 wt. % of chromium, 3-8% of aluminium, and up to 20 wt. % of nickel. The alloys may also contain small or trace amounts of one or more metals such as manganese, copper, vanadium, titanium, and the like. The surface of the metal substrate may be oxidized at high temperature, e.g., 1000° C. and higher, to form an oxide layer on the surface of the substrate, improving the corrosion resistance of the alloy and facilitating adhesion of the washcoat layer to the metal surface.

Preferable ceramic materials used to construct the substrate may include any suitable refractory material, e.g., cordierite, mullite, cordierite-alumina, silicon nitride, zircon mullite, spodumene, alumina-silica magnesia, zircon silicate, sillimanite, magnesium silicates, zircon, petalite, alumina, aluminosilicates, and the like.

Any suitable substrate may be employed, such as a monolithic flow-through substrate having a plurality of fine, parallel gas flow passages extending from an inlet to an outlet face of the substrate such that passages are open to fluid flow. The passages, which are essentially straight paths from the inlet to the outlet, are defined by walls on which the catalytic material is coated as a washcoat so that the gases flowing through the passages contact the catalytic material. The flow passages of the monolithic substrate are thin-walled channels which are of any suitable cross-sectional shape, such as trapezoidal, rectangular, square, sinusoidal, hexagonal, oval, circular, and the like. Such structures contain from about 60 to about 1200 or more gas inlet openings (i.e., “cells”) per square inch of cross section (cpsi), more usually from about 300 to 900 cpsi. The wall thickness of flow-through substrates can vary, with a typical range being between 0.002 and 0.1 inches. A representative commercially available flow-through substrate is a cordierite substrate having 400 cpsi and a wall thickness of 6 mil, or 600 cpsi and a wall thickness of 4 mil. However, it will be understood that the invention is not limited to a particular substrate type, material, or geometry. In alternative embodiments, the substrate may be a wall-flow substrate, wherein each passage is blocked at one end of the substrate body with a non-porous plug, with alternate passages blocked at opposite end-faces. This requires that gas flow through the porous walls of the wall-flow substrate to reach the exit. Such monolithic substrates may contain up to about 700 or more cpsi, such as about 100 to 400 cpsi and more typically about 200 to about 300 cpsi. The cross-sectional shape of the cells can vary as described above. Wall-flow substrates typically have a wall thickness between 0.002 and 0.1 inches. A representative commercially available wall-flow substrate is constructed from a porous cordierite, an example of which has 200 cpsi and 10 mil wall thickness or 300 cpsi with 8 mil wall thickness, and wall porosity between 45-65%. Other ceramic materials such as aluminium-titanate, silicon carbide and silicon nitride are also used as wall-flow filter substrates. However, it will be understood that the invention is not limited to a particular substrate type, material, or geometry. Note that where the substrate is a wall-flow substrate, the catalyst composition can permeate into the pore structure of the porous walls (i.e., partially or fully occluding the pore openings) in addition to being disposed on the surface of the walls. In one embodiment, the substrate has a flow through ceramic honeycomb structure, a wall-flow ceramic honeycomb structure, or a metal honeycomb structure.

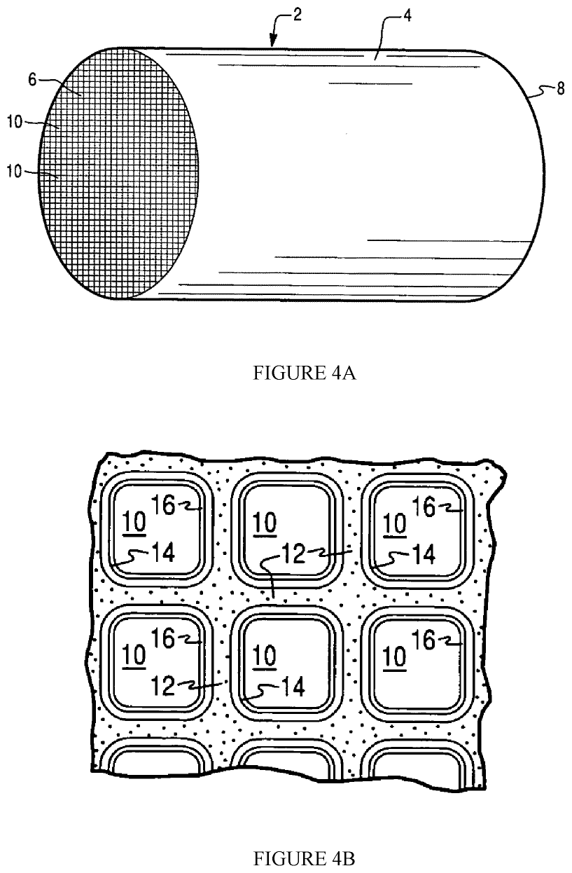

FIGS. 4A and 4B illustrate an exemplary substrate 2 in the form of a flow-through substrate coated with washcoat compositions/catalytic layer/s as described herein. Referring to FIG. 4A, the exemplary substrate 2 has a cylindrical shape and a cylindrical outer surface 4, an upstream end face 6 and a corresponding downstream end face 8, which is identical to end face 6. Substrate 2 has a plurality of fine, parallel gas flow passages 10 formed therein. As seen in FIG. 4B, flow passages 10 are formed by walls 12 and extend through substrate 2 from upstream end face 6 to downstream end face 8, the passages 10 being unobstructed so as to permit the flow of a fluid, e.g., a gas stream, longitudinally through substrate 2 via gas flow passages 10 thereof. As more easily seen in FIG. 4B, walls 12 are so dimensioned and configured that gas flow passages 10 have a substantially regular polygonal shape. As shown, the washcoat compositions/catalytic layers can be applied in multiple, distinct layers if desired. In the illustrated embodiment, the washcoats consist of a discrete first washcoat layer 14 adhered to the walls 12 of the substrate member and a second discrete washcoat layer 16 coated over the first washcoat layer 14. In one embodiment, the presently claimed invention is also practiced with two or more (e.g., 3, or 4) washcoat layers and is not limited to the illustrated two-layer embodiment.

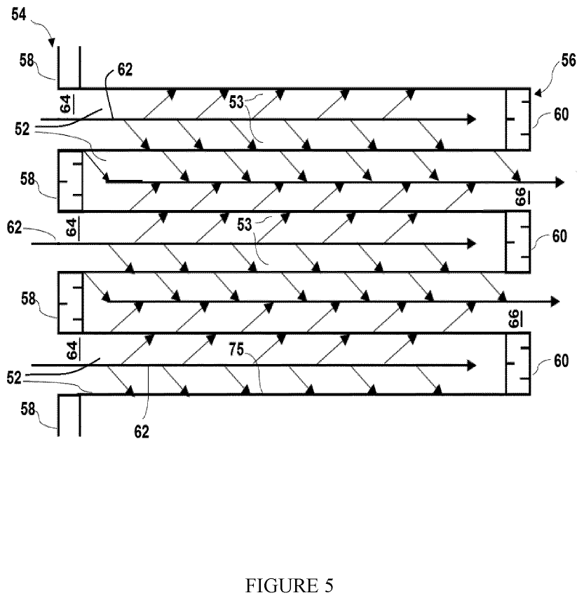

FIG. 5 illustrates an exemplary substrate 2 in the form of a wall flow filter substrate coated with a washcoat composition as described herein. As seen in FIG. 5, the exemplary substrate 2 has a plurality of passages 52. The passages are tubularly enclosed by the internal walls 53 of the filter substrate. The substrate has an inlet end 54 and an outlet end 56. Alternate passages are plugged at the inlet end with inlet plugs 58 and at the outlet end with outlet plugs 60 to form opposing checkerboard patterns at the inlet 54 and outlet 56. A gas stream 62 enters through the unplugged channel inlet 64, is stopped by outlet plug 60 and diffuses through channel walls 53 (which are porous) to the outlet side 66. The gas cannot pass back to the inlet side of walls because of inlet plugs 58. The porous wall flow filter used in this invention is catalysed in that the wall of said element has thereon or contained therein one or more catalytic materials. Catalytic materials may be present on the inlet side of the element wall alone, the outlet side alone, both the inlet and outlet sides, or the wall itself may consist all, or in part, of the catalytic material. This invention includes the use of one or more layers of catalytic material on the inlet and/or outlet walls of the element.

### Washcoat/s On Substrate

The substrate is coated with catalytic layers, namely a first catalytic layer and a second catalytic layer in a zoned fashion. A first zone is coated with the first catalytic layer and a second zone is coated with the second catalytic layer. The first catalytic layer covers 60 to 100% area of the first zone and the second catalytic layer covers 60 to 100% area of the second zone.

The first zone occupies a flow-in end portion of the substrate and the second zone occupies a flow-out end portion of the substrate.

The first zone and the second zone together cover 50 to 100% of length of the substrate. Preferably, the first and second zone together cover 90 to 100% of the length of the substrate and more preferably, the first and the second zone together cover the whole length or the whole accessible surface area of the substrate.

The term “accessible surface” refers to the surface of the substrate which can be covered with the conventional coating techniques used in the field of catalyst preparation like impregnation techniques.

Preferably, the first zone covers 10 to 90% of the entire substrate length from an inlet and the second zone covers 90 to 10% of the entire substrate length from an outlet, while the first zone and the second zone together cover 20 to 100% of the length of the substrate. More preferably, the first zone covers 20 to 80% of the entire substrate length from the inlet and the second zone covers 80 to 20% of the entire substrate length from the outlet, while the first zone and the second zone together cover 40 to 100% of the length of the substrate. Even more preferably, the first zone covers 30 to 70% of the entire substrate length from the inlet and the second zone covers 70 to 30% of the entire substrate length from the outlet, while the first zone and the second zone together cover 60 to 100% of the length of the substrate. Even most preferably, the first zone covers 40 to 50% of the entire substrate length from the inlet and the second zone covers 50 to 40% of the entire substrate length from the outlet, while the first zone and the second zone together cover 80 to 100% of the length of the substrate.

### First Zone

The first zone is coated with the first catalytic layer which comprises platinum supported on ceria-zirconia mixed oxide or ceria-alumina composite or both; and rhodium supported on ceria-zirconia mixed oxide or ceria-alumina composite or both.

Preferably, the first catalytic layer covers 60 to 100% area of the first zone. More preferably, the first catalytic layer covers 70 to 100% area of the first zone. Most preferably, the first catalytic layer covers 80 to 100% area of the first zone.

Preferably, the amount of platinum in the first catalytic layer is 0.02 to 3.0 wt. %, based on the total weight of the first catalytic layer. More preferably, the amount of platinum in the first catalytic layer is 0.02 to 2.5 wt. %, based on the total weight of the first catalytic layer. Even more preferably, the amount of platinum in the first catalytic layer is 0.05 to 2.0 wt. %, based on the total weight of the first catalytic layer

The amount of platinum supported on ceria-zirconia mixed oxide or ceria-alumina composite or both in the first catalytic layer is preferably 60 to 100 wt. %, based on the total weight of platinum in the first and the second catalytic layer. More preferably, the amount of platinum supported on ceria-zirconia mixed oxide or ceria-alumina composite or both in the first catalytic layer is 70 to 100 wt. %, based on the total weight of platinum in the first and the second catalytic layer. Most preferably, the amount of platinum supported on ceria-zirconia mixed oxide or ceria-alumina composite or both in the first catalytic layer is 80 to 100 wt. %, based on the total weight of platinum in the first and the second catalytic layer.

The first catalytic layer also comprises rhodium supported on the ceria-zirconia mixed oxide or ceria-alumina composite or both. Preferably, the total amount of rhodium in the first catalytic layer is 0.01 to 1.0 wt. %, based on the total weight of the first catalytic layer. More preferably, the total amount of rhodium in the first catalytic layer is 0.01 to 0.5 wt. %, based on the total weight of the first catalytic layer.

Preferably, the amount of rhodium supported on the ceria-zirconia mixed oxide or ceria- alumina composite or both in the first catalytic layer is 50 to 100 wt. %, based on the total weight of rhodium in the first and the second catalytic layer. More preferably, the amount of rhodium supported on the ceria-zirconia mixed oxide or ceria-alumina composite or both in the first catalytic layer is 75 to 100 wt. %, based on the total weight of rhodium in the first and the second catalytic layer.

Additionally, the first catalytic layer preferably comprises palladium. Preferably, palladium is supported on ceria-zirconia mixed oxide or ceria-alumina composite or both. More preferably, palladium is supported on the ceria-zirconia mixed oxide. Preferably, the amount of palladium in the first layer is 0 to 50 wt. %, based on the total weight of palladium present in the first and the second layer. More preferably, the amount of palladium in the first layer is 0.1 to 30 wt. %, based on the total weight of palladium present in the first and the second layer.

Even more preferably, the amount of palladium in the first layer is 0.1 to 25 wt. %, based on the total weight of palladium present in the first and the second layer.

The amount of ceria-zirconia mixed oxide in the first catalytic layer is preferably in the range of 20 to 80 wt. %, based on the total weight of the first catalytic layer. More preferably, the amount of ceria-zirconia mixed oxide in the first catalytic layer is in the range of 25 to 70 wt. %, based on the total weight of the first catalytic layer. Most preferably, the amount ceria-zirconia mixed oxide in the first catalytic layer is in the range of 30 to 60 wt. %, based on the total weight of the first catalytic layer.

The ceria-zirconia mixed oxide preferably comprises ceria, calculated as CeO₂ in an amount of about 10 to 60 wt. %, based on the total weight of the ceria-zirconia mixed oxide present in the first catalytic layer; and zirconia, calculated as ZrO₂ in an amount of about 40 to about 90 wt. %, based on the total weight the ceria-zirconia mixed oxide present in the first catalytic layer. More preferably, the ceria-zirconia mixed oxide comprises ceria, calculated as CeO₂ in an amount of about 20 to 50 wt. %, based on the total weight of the ceria-zirconia mixed oxide present in the first catalytic layer; and zirconia, calculated as ZrO₂ in an amount of about 50 to about 80 wt. %, based on the total weight the ceria-zirconia mixed oxide present in the first catalytic layer. Even more preferably, ceria (calculated as CeO₂) of the ceria-zirconia mixed oxide present in the first layer is present in an amount of 30 to 50 wt. %, based on the total weight of the ceria-zirconia mixed oxide in the first catalytic layer and zirconia (calculated as ZrO₂) of the ceria-zirconia mixed oxide present in the first layer is present in an amount of 50 to 70 wt. %, based on the total weight of the ceria-zirconia mixed oxide in the first layer.

Preferably, the amount of the ceria-alumina composite in the first catalytic layer is in the range of 10 to 80 wt. %, based on the total weight of the first catalytic layer. More preferably, the amount of the ceria-alumina composite in the first catalytic layer is in the range of 20 to 70 wt. %, based on the total weight of the first catalytic layer. More preferably, the amount of the ceria- alumina composite in the first catalytic layer is in the range of 30 to 60 wt. %, based on the total weight of the first catalytic layer.

Preferably the amount of ceria, calculated as CeO2 in the ceria-alumina composite present in the first layer is 1.0 to 60 wt. %, based on the total weight of the ceria-alumina composite present in the first catalytic layer. More preferably, the amount of ceria, calculated as CeO₂ in the ceria-alumina composite present in the first layer is 5.0 to 50 wt. %, based on the total weight of the ceria-alumina composite present in the first catalytic layer. More preferably, the amount of ceria, calculated as CeO₂ in the ceria-alumina composite present in the first layer is 5.0 to 30 wt. %, based on the total weight of the ceria-alumina composite present in the first catalytic layer. Even more preferably, the amount of ceria, calculated as CeO₂ in the ceria-alumina composite present in the first layer is 8.0 to 20 wt. %, based on the total weight of the ceria-alumina composite present in the first catalytic layer.

### Second Zone

The second zone is coated with the second catalytic layer which comprises palladium supported on ceria-zirconia mixed oxide, alumina, ceria-alumina composite or any combination thereof; and rhodium supported on ceria-zirconia mixed oxide, alumina, ceria-alumina composite or any combination thereof. Preferably, the second catalytic layer covers 60 to 100% area of the second zone. More preferably, the second catalytic layer covers 70 to 100% area of the second zone. Most preferably, the second catalytic layer covers 80 to 100% area of the second zone.

Preferably, the amount of palladium is in the range of 0.02 to 5.0 wt. %, based on the total weight of the second catalytic layer. More preferably, the amount of palladium is in the range of 0.02 to 4.0 wt. %, based on the total weight of the second catalytic layer. The amount of palladium supported on the ceria-zirconia mixed oxide, alumina, ceria-alumina composite or any combination thereof in the second catalytic layer is preferably 50 to 100 wt. %, based on the total weight of palladium in the first catalytic layer and the second catalytic layer. More preferably, the amount of palladium supported on the ceria-zirconia mixed oxide, alumina, ceria-alumina composite or any combination thereof in the second catalytic layer is 60 to 100 wt. %, based on the total weight of palladium in the first catalytic layer and the second catalytic layer. Most preferably, the amount of palladium supported on the ceria-zirconia mixed oxide, alumina, ceria-alumina composite or any combination thereof in the second catalytic layer is 75 to 100 wt. %, based on the total weight of palladium in the first catalytic layer and the second catalytic layer.

The second catalytic layer preferably comprises rhodium supported on the ceria-zirconia mixed oxide, alumina, ceria-alumina composite or any combination thereof.

Preferably, the amount of rhodium is in the range of 0.01 to 1.0 wt. %, based on the total weight of the second catalytic layer. More preferably, the amount of rhodium is in the range of 0.03 to 0.5 wt. %, based on the total weight of the second catalytic layer.

Preferably, the amount of rhodium supported on the ceria-zirconia mixed oxide, alumina, ceria-alumina composite or any combination thereof in the second catalytic layer is preferably 0 to 50 wt. %, based on the total weight of rhodium in the first catalytic layer and the second catalytic layer. More preferably, the amount of rhodium supported on the ceria-zirconia mixed oxide, alumina, ceria-alumina composite or any combination thereof in the second catalytic layer is 0 to 25 wt. %, based on the total weight of rhodium in the first catalytic layer and the second catalytic layer.

The second catalytic layer optionally comprises platinum supported on ceria-zirconia mixed oxide, alumina, ceria-alumina composite or any combination thereof. Preferably, the amount of platinum supported on ceria-zirconia mixed oxide, alumina, ceria-alumina composite or any combination thereof is 0 to 50 wt. % based on the total weight of the platinum present in the first and the second layer. More preferably, the amount of platinum supported on ceria-zirconia mixed oxide, alumina, ceria-alumina composite or any combination thereof is 0.1 to 30 wt. % based on the total weight of the platinum present in the first and the second layer. Even more preferably, the amount of platinum supported on ceria-zirconia mixed oxide, alumina, ceria-alumina composite or any combination thereof is 0.1 to 25 wt. % based on the total weight of the platinum present in the first and the second layer.

The amount of ceria-zirconia mixed oxide in the second catalytic layer is in the range of 20 to 80 wt. %, based on the total weight of the second catalytic layer. Preferably, the amount of ceria-zirconia mixed oxide in the second catalytic layer is in the range of 25 to 70 wt. %, based on the total weight of the second catalytic layer. More preferably, the of amount ceria-zirconia mixed oxide in the second catalytic layer is in the range of 30 to 60 wt. %, based on the total weight of the second catalytic layer.

The ceria-zirconia mixed oxide preferably comprises ceria, calculated as CeO₂ in an amount of about 10 to 60 wt. %, based on the total weight of the ceria-zirconia mixed oxide present in the second catalytic layer; and zirconia, calculated as ZrO₂ in an amount of about 40 to about 90 wt. %, based on the total weight the ceria-zirconia mixed oxide present in the second catalytic layer. More preferably, the ceria-zirconia mixed oxide comprises ceria, calculated as CeO₂ in an amount of about 20 to 50 wt. %, based on the total weight of the ceria-zirconia mixed oxide present in the second catalytic layer; and zirconia, calculated as ZrO₂ in an amount of about 50 to about 80 wt. %, based on the total weight the ceria-zirconia mixed oxide present in the second catalytic layer. Even more preferably, ceria (calculated as CeO₂) of the ceria-zirconia mixed oxide present in the second layer is present in an amount of 30 to 50 wt. %, based on the total weight of the ceria-zirconia mixed oxide in the second catalytic layer and zirconia (calculated as ZrO₂) of the ceria-zirconia mixed oxide present in the layer is present in an amount of 50 to 70 wt. %, based on the total weight of the ceria-zirconia mixed oxide in the second catalytic layer.

The amount of alumina in the second catalytic layer is preferably in the range of 5.0 to 50 wt. %, based on the total weight of the second catalytic layer. More preferably, the amount of alumina in the second catalytic layer is in the range of 10 to 40 wt. %, based on the total weight of the second catalytic layer.

Preferably, the amount of the ceria-alumina composite in the second catalytic layer is in the range of 1.0 to 40 wt. %, based on the total weight of the second catalytic layer. More preferably, the amount of the ceria-alumina composite in the second catalytic layer is in the range of 1.0 to 30 wt. %, based on the total weight of the first catalytic layer. More preferably, the amount of the ceria-alumina composite in the second catalytic layer is in the range of 1.0 to 20 wt. %, based on the total weight of the second catalytic layer.

Preferably, the amount of ceria, calculated as CeO₂ in the ceria-alumina composite present in the second layer is 1.0 to 60 wt. %, based on the total weight of the ceria-alumina composite present in the second catalytic layer. More preferably, the amount of ceria, calculated as CeO₂ in the ceria-alumina composite present in the second layer is 5.0 to 50 wt. %, based on the total weight of the ceria-alumina composite present in the second catalytic layer. More preferably, the amount of ceria, calculated as CeO₂ in the ceria-alumina composite present in the second layer is 5.0 to 30 wt. %, based on the total weight of the ceria-alumina composite present in the second catalytic layer. Even more preferably, the amount of ceria, calculated as CeO₂ in the ceria-alumina composite present in the second layer is 8.0 to 20 wt. %, based on the total weight of the ceria-alumina composite present in the second catalytic layer.

Preferably, the weight proportion rhodium supported on ceria-zirconia mixed oxide or ceria-alumina composite or both in the first catalytic layer to rhodium supported on ceria-zirconia mixed oxide, alumina, ceria-alumina composite or any combination thereof in the second catalytic layer is in the range of 1.5:1 to 4:1.

### Overcoat

The first zone further comprises an overcoat which is deposited at least on a part of the first zone. The overcoat comprises a porous refractory oxide, and optionally, at least one base metal oxide.

As used herein, “porous refractory oxide” refers to porous metal-containing oxide materials exhibiting chemical and physical stability at high temperatures. Exemplary refractory oxides include alumina, silica, zirconia, titania, ceria, and physical mixtures or chemical combinations thereof, including atomically doped combinations and including high surface area or activated compounds such as activated alumina.

Preferably, the porous refractory oxide is stabilized or non-stabilized aluminum oxide. Preferably, the loading of the overcoat divided by substrate volume coated by the overcoat is less than 1 gram per cubic inch.

Preferably, the overcoat is essentially free of precious metal/s and optionally, comprises an oxygen storage component. The term “essentially free of precious metal/s” means no precious metal is added in the overcoat. It may present as an impurity in an amount of less than 0.001 wt. %. Preferably, the base metal oxide is an alkaline earth metal oxide or a rare earth metal oxide. The alkaline earth metal oxide is preferably selected from barium oxide, magnesium oxide, calcium oxide, strontium oxide or a combination thereof. More preferably, the alkaline earth metal oxide is selected from barium oxide and strontium oxide. Most preferably, the alkaline earth metal oxide is barium oxide.

Preferably, the rare earth metal oxide is at least one oxide of a rare earth metal selected from Ce, Pr, Nd, Eu, Sm, Yb, and La, or a mixture thereof. More preferably, the rare earth metal oxide is at least one oxide of a rare earth metal selected from Ce, Pr, and La, or a mixture thereof.

Preferably, the length of the overcoat is equal or less than 50% of total length of the substrate. More preferably, the length of the overcoat is equal or less than 35% of total length of the substrate. Most preferably, the length of the overcoat is equal or less than 32% of total length of the substrate.

### Preparation of Catalytic Article

In another aspect of the present invention, there is also provided a process for the preparation of a catalytic article described herein above. The process comprises the following steps:
A first catalytic layer slurry comprising platinum supported on ceria-zirconia mixed oxide or ceria-alumina composite or both; and rhodium supported on ceria-zirconia mixed oxide, ceria-alumina composite, alumina or any combination thereof is prepared.
A second catalytic layer slurry comprising palladium supported on ceria-zirconia mixed oxide, alumina, ceria-alumina composite or any combination thereof; and rhodium supported on ceria-zirconia mixed oxide, alumina, ceria-alumina composite or any combination thereof is prepared.
The first catalytic layer slurry is coated on the flow-in end portion of the substrate to obtain a first zone.
The second catalytic layer slurry is coated on the flow-out end portion of the substrate to obtain a second zone.
The substrate is then subjected to calcination at a temperature ranging from 400 to 700° C.

The step of preparing the slurry comprises a technique selected from incipient wetness impregnation, incipient wetness co-impregnation, and post-addition.

Incipient wetness impregnation techniques, also called capillary impregnation or dry impregnation are commonly used for the synthesis of heterogeneous materials, i.e., catalysts. Typically, a metal precursor is dissolved in an aqueous or organic solution and then the metal-containing solution is added to a catalyst support containing the same pore volume as the volume of the solution that was added. Capillary action draws the solution into the pores of the support. Solution added in excess of the support pore volume causes the solution transport to change from a capillary action process to a diffusion process, which is much slower. The catalyst is dried and calcined to remove the volatile components within the solution, depositing the metal on the surface of the catalyst support. The concentration profile of the impregnated material depends on the mass transfer conditions within the pores during impregnation and drying.

The support particles are typically dry enough to absorb substantially all of the solution to form a moist solid. Aqueous solutions of water-soluble compounds or complexes of the active metal are typically utilized, such as rhodium chloride, rhodium nitrate (e.g., Rh (NO)₃ and salts thereof), rhodium acetate, or combinations thereof where rhodium is the active metal; palladium nitrate, palladium tetra amine nitrate, palladium acetate, or combinations thereof where palladium is the active metal; and platinum nitrate, platinum acetate, or combination thereof where platinum is the active metal. Following treatment of the support particles with the active metal solution, the particles are dried, such as by heat treating the particles at elevated temperature (e.g., 100-150° C.) for a period of time (e.g., 1-3 hours), and then calcined to convert the active metal to a more catalytically active form. An exemplary calcination process involves heat treatment in air at a temperature of about 400-550° C. for 10 min to 3 hours. The above process can be repeated as needed to reach the desired level of active metal impregnation.

### Substrate Coating

The above-noted catalyst compositions are typically prepared in the form of catalyst particles as noted above. These catalyst particles are mixed with water to form a slurry for purposes of coating a catalyst substrate, such as a honeycomb-type substrate. In addition to the catalyst particles, the slurry may optionally contain a binder in the form of alumina, silica, zirconium acetate, colloidal zirconia, or zirconium hydroxide, associative thickeners, and/or surfactants (including anionic, cationic, non-ionic, or amphoteric surfactants). Other exemplary binders include boehmite, gamma-alumina, or delta/theta alumina, as well as silica sol. When present, the binder is typically used in an amount of about 1.0-5.0 wt. % of the total washcoat loading. Addition of acidic or basic species to the slurry is carried out to adjust the pH accordingly. For example, in some embodiments, the pH of the slurry is adjusted by the addition of ammonium hydroxide, aqueous nitric acid, or acetic acid. A typical pH range for the slurry is about 3.0 to 12. The slurry can be milled to reduce the particle size and enhance particle mixing. The milling is accomplished in a ball mill, continuous mill, or other similar equipment, and the solids content of the slurry may be, e.g., about 20-60 wt. %, more particularly about 20-40 wt. %. In one embodiment, the post-milling slurry is characterized by a D90 particle size of about 10 to about 40 microns, preferably 10 to about 30 microns, more preferably about 10 to about 15 microns. The D90 is determined using a dedicated particle size analyzer. The equipment employed in this example uses laser diffraction to measure particle sizes in small volume slurry. The D90, typically with units of microns, means 90% of the particles by number have a diameter less than that value.

The slurry is coated on the catalyst substrate using any washcoat technique known in the art. E.g., the catalyst substrate is dipped one or more times in the slurry or otherwise coated with the slurry. Thereafter, the coated substrate is dried at an elevated temperature (e.g., 100-150° C.) for a period of time (e.g., 10 min-3.0 hours) and then calcined by heating, e.g., at 400-700° C., typically for about 10 minutes to about 3 hours. Following drying and calcining, the final washcoat coating layer is viewed as essentially solvent-free.

After calcining, the catalyst loading obtained by the above described washcoat technique can be determined through calculation of the difference in coated and uncoated weights of the substrate. As will be apparent to those of skill in the art, the catalyst loading can be modified by altering the slurry rheology. In addition, the coating/drying/calcining process to generate a washcoat can be repeated as needed to build the coating to the desired loading level or thickness, meaning more than one washcoat may be applied.

The coated substrate can be aged, by subjecting the coated substrate to heat treatment. E.g., aging is done at a temperature of about 850° C. to about 1050° C. in the presence of steam under gasoline engine exhaust conditions for 50-300 hours. Aged catalyst articles are thus provided according to present invention. The effective support material such as ceria-alumina composites maintains a high percentage (e.g., about 50-100%) of their pore volumes upon aging (e.g., at about 850° C. to about 1050° C. in the presence of steam for about 50-300 hours aging).

### Emission Treatment System

In another aspect of the present invention, there is also provided an exhaust gas treatment system for internal combustion engines, said system comprising the catalytic article described hereinabove. In one illustration, the system comprises the catalytic article according to the presently claimed invention and an additional platinum group metal based three-way conversion (TWC) catalytic article. The catalytic article of the present invention may be placed in a close-coupled position. Close-coupled catalysts are placed close to an engine to enable them to reach reaction temperatures as soon as possible. In general, the close-coupled catalyst is placed within three feet, more specifically, within one foot of the engine, and even more specifically, less than six inches from the engine. Close-coupled catalysts are often attached directly to the exhaust gas manifold. Due to their proximity to the engine, close-coupled catalysts are required to be stable at high temperatures. The catalytic article of the invention can also be used as part of an integrated exhaust system comprising one or more additional components for the treatment of exhaust gas emissions. For example, the exhaust system also known as emission treatment system may further comprise a close coupled TWC catalyst, an underfloor TWC catalyst, a catalysed soot filter (CSF) component, and/or a selective catalytic reduction (SCR) catalytic article. The preceding list of components is merely illustrative and should not be taken as limiting the scope of the invention.

In another aspect of the present invention, there is also provided a method of treating a gaseous exhaust stream comprising hydrocarbons, carbon monoxide, and nitrogen oxide, the method comprising contacting said exhaust stream with the catalytic article according to the present invention or the exhaust gas treatment system according to the present invention. The present invention also provides a method of reducing hydrocarbons, carbon monoxide, and nitrogen oxide levels in a gaseous exhaust stream, the method comprising contacting a gaseous exhaust stream with the catalytic article according to the present invention or the exhaust gas treatment system according to the present invention to reduce the levels of hydrocarbons, carbon monoxide, and nitrogen oxide in the exhaust gas.

In another aspect of the present invention, there is also provided use of the catalytic article or the exhaust gas treatment system according to the presently claimed invention for purifying a gaseous exhaust stream comprising hydrocarbons, carbon monoxide, and nitrogen oxide.

The present invention is further illustrated by the following set of embodiments and combinations of embodiments resulting from the dependencies and back-references as indicated. In particular, it is noted that in each instance where a range of embodiments is mentioned, for example in the context of a term such as “The process accordingly to any one of embodiments 1 to 4”, every embodiment in this range is meant to be explicitly disclosed for the skilled person i.e. the wording of this term is to be understood by the skilled person as being synonymous to “The process according to any one of embodiments 1, 2, 3 and 4”. Further, it is explicitly noted that the following set of embodiments is not the set of claims determining the extent of protection, but represent a suitably structured part of the description directed to general and preferred aspects of the present invention.

### Embodiment 1

The present invention provides a catalytic article comprising:
a) a substrate;
b) a first zone coated with a first catalytic layer; and
c) a second zone coated with a second catalytic layer,
wherein the first catalytic layer comprises platinum supported on ceria-zirconia mixed oxide or ceria-alumina composite or both; and rhodium supported on ceria-zirconia mixed oxide, ceria-alumina composite, alumina or any combination thereof,
wherein the second catalytic layer comprises palladium supported on ceria-zirconia mixed oxide, alumina, ceria-alumina composite or any combination thereof; and rhodium supported on ceria-zirconia mixed oxide, alumina, ceria-alumina composite or any combination thereof,
wherein the first zone occupies a flow-in end portion of the substrate and the second zone occupies a flow-out end portion of the substrate.

### Embodiment 2

The catalytic article according to embodiment 1, wherein the first catalytic layer further comprises palladium supported on ceria-zirconia mixed oxide or ceria-alumina composite or both.

### Embodiment 3

The catalytic article according to any of embodiments 1 to 2, wherein the second catalytic layer further comprises platinum supported on ceria-zirconia mixed oxide, ceria-alumina composite, alumina or any combination thereof.

### Embodiment 4

The catalytic article according to any of embodiments 1 to 3, wherein a total loading of the first catalytic layer and the second catalytic layer divided by substrate volume is less than 3.2 gram per cubic inch.

### Embodiment 5

The catalytic article according to any of embodiments 1 to 4, wherein the amount of platinum in the first catalytic layer and the second catalytic layer is in the range of 0.02 to 3.0 wt. %, based on the total weight of the first catalytic layer and the second catalytic layer, wherein the amount of palladium in the first catalytic layer and the second catalytic layer is in the range of 0.02 to 5.0 wt. %, based on the total weight of the first catalytic layer and the second catalytic layer, and wherein the amount of rhodium in the first catalytic layer and the second catalytic layer is in the range of 0.01 to 1.0 wt. %, based on the total weight of the first catalytic layer and the second catalytic layer.

### Embodiment 6

The catalytic article according to any of embodiments 1 to 5, wherein the total amount of platinum supported on ceria-zirconia mixed oxide or ceria-alumina composite or both in the first catalytic layer is 80 to 100 wt. %, based on the total weight of platinum in the first and the second catalytic layer, wherein the total amount of palladium supported on ceria-zirconia mixed oxide, alumina, ceria-alumina composite or any combination thereof in the second catalytic layer is 75 to 100 wt. %, based on the total weight of palladium in the first catalytic layer and the second catalytic layer, and wherein the weight proportion rhodium supported on ceria-zirconia mixed oxide or ceria-alumina composite or both in the first catalytic layer to rhodium supported on ceria-zirconia mixed oxide, alumina, ceria-alumina composite or any combination thereof in the second catalytic layer is in the range of 1.5:1 to 4:1.

### Embodiment 7

The catalytic article according to any of embodiments 1 to 6, wherein the first zone further comprises an overcoat deposited at least on a part of the first zone, wherein the overcoat comprises a porous refractory oxide, and optionally, at least one base metal oxide.

### Embodiment 8

The catalytic article according to embodiment 7, wherein the overcoat is essentially free of precious metal/s and optionally, comprises an oxygen storage component.

### Embodiment 9

The catalytic article according to any of embodiments 7 to 8, wherein the length of the overcoat is equal or less than 50% of total length of the substrate.

### Embodiment 10

The catalytic article according to any of embodiments 7 to 9, wherein a loading of the overcoat divided by substrate volume coated by the overcoat is less than 1 gram per cubic inch.

### Embodiment 11

The catalytic article according to any of embodiments 7 to 10, wherein the porous refractory oxide is stabilized or non-stabilized aluminum oxide.

### Embodiment 12

The catalytic article according to any of embodiments 7 to 11, wherein the base metal oxide is an alkaline earth metal oxide or a rare earth metal oxide, wherein the alkaline earth metal oxide is selected from barium oxide, magnesium oxide, calcium oxide, strontium oxide, or a combination thereof, wherein the rare earth metal oxide is at least one oxide of a rare earth metal selected from Ce, Pr, Nd, Eu, Sm, Yb, and La, or a mixture thereof.

### Embodiment 13

The catalytic article according to any of embodiments 1 to 12, wherein the first zone covers 10 to 90% of the entire substrate length from the flow-in end portion, wherein the second zone covers 10 to 90% of the entire substrate length from the flow-out end portion, wherein the first catalytic layer covers 60 to 100% area of the first zone and the second the second catalytic layer covers 60 to 100% area of the second zone.

### Embodiment 14

The catalytic article according to any of embodiments 1 to 13, wherein the first zone covers 40 to 60% of the entire substrate length from the flow-in end portion, wherein the second zone covers 60 to 40% of the entire substrate length from the flow-out end portion.

### Embodiment 15

The catalytic article according to any of embodiments 1 to 14, wherein the amount of the ceria-zirconia mixed oxide present in the first catalytic layer and the second catalytic layer is 40 to 60 wt. %, based on the total weight of the first catalytic layer and the second catalytic layer.

### Embodiment 16

The catalytic article according to any of embodiments 1 to 15, wherein the amount of the alumina present in the first catalytic layer and the second catalytic layer is in the range of 5 to 20 wt. %, based on the total weight of the first catalytic layer and the second catalytic layer.

### Embodiment 17

The catalytic article according to any of embodiments 1 to 16, wherein the alumina is doped with a dopant selected from barium, lanthana, zirconia, neodymian, yttria, ceria or titania, wherein the amount of the dopant is 1.0 to 30 wt. % based on the total weight of alumina and dopant present in the first catalytic layer and the second catalytic layer.

### Embodiment 18

The catalytic article according to any of embodiments 1 to 17, wherein the alumina is selected from alumina, lanthana-alumina, titania-alumina, ceria-zirconia-alumina, zirconia-alumina, ceria-alumina, lanthana-zirconia-alumina, baria-alumina, baria-lanthana-alumina, baria-lanthana-neodymia-alumina, or any combination thereof.

### Embodiment 19

The catalytic article according to any of embodiments 1 to 18, wherein the amount of the ceria- alumina composite present in the first catalytic layer and the second catalytic layer is in the range of 15 to 40 wt. %, based on the total weight of the first catalytic layer and the second catalytic layer.

### Embodiment 20

The catalytic article according to any of embodiments 1 to 19, wherein the amount of ceria, calculated as CeO₂ in the ceria-alumina composite is 5.0 to 30 wt. %, based on the total weight of the ceria-alumina composite.

### Embodiment 21

The catalytic article according to any of embodiments 1 to 20, wherein the ceria-zirconia mixed oxide present in the first catalytic layer and second catalytic layer comprises ceria, calculated as CeO₂ in an amount of 15 to 50 wt. %, based on the total weight of the ceria-zirconia mixed oxide in the respective catalytic layer; and zirconia, calculated as ZrO2 in an amount of 50 to about 85 wt. %, based on the total weight of the ceria-zirconia mixed oxide in the respective catalytic layer.

### Embodiment 22

The catalytic article according to any of embodiments 1 to 21, wherein the ceria-zirconia mixed oxide present in the first catalytic layer and second catalytic layer comprises a dopant selected from lanthana, titania, hafnia, magnesia, calcia, strontia, baria, yttrium, hafnium, praseodymium, neodymium, or any combinations thereof.

### Embodiment 23

The catalytic article according to any of embodiments 1 to 22, wherein the substrate is selected from a ceramic substrate, a metal substrate, a ceramic foam substrate, a polymer foam substrate, or a woven fiber substrate.

### Embodiment 24

The present invention provides a process for the preparation of the catalytic article according to any of embodiments 1 to 23, wherein said process comprises:
preparing a first catalytic layer slurry comprising platinum supported on ceria-zirconia mixed oxide or ceria-alumina composite or both; and rhodium supported on ceria-zirconia mixed oxide, ceria-alumina composite, alumina or any combination thereof;
preparing a second catalytic layer slurry comprising palladium supported on ceria-zirconia mixed oxide, alumina, ceria-alumina or any combination thereof; and rhodium supported on ceria-zirconia mixed oxide, alumina, ceria-alumina composite or any combination thereof;
coating the first catalytic layer slurry on the flow-in end portion of the substrate to obtain a first zone;
coating the second catalytic layer slurry on the flow-out end portion of the substrate to obtain a second zone;
subjecting the substrate to calcination at a temperature ranging from 400 to 700° C.,
   wherein the step of preparing the slurry comprises a technique selected from incipient wetness impregnation, incipient wetness co-impregnation, and post-addition.

### Embodiment 25

The present invention provides an exhaust gas treatment system for internal combustion engines, said system comprising the catalytic article according to any of embodiments 1 to 23.

### Embodiment 26

The present invention provides a method of treating a gaseous exhaust stream comprising hydrocarbons, carbon monoxide, and nitrogen oxide, the method comprising contacting said exhaust stream with the catalytic article according to any of embodiments 1 to 23 or the exhaust gas treatment system according to embodiment 25.

### Embodiment 27

The present invention provides a method of reducing hydrocarbons, carbon monoxide, and nitrogen oxide levels in a gaseous exhaust stream, the method comprising contacting a gaseous exhaust stream with the catalytic article according to any of embodiments 1 to 23 or the exhaust gas treatment system according to claim 25 to reduce the levels of hydrocarbons, carbon monoxide, and nitrogen oxide in the exhaust gas.

### Embodiment 28

The present invention provides use of the catalytic article according to any of embodiments 1 to 23 or the exhaust gas treatment system according to embodiment 25 for purifying a gaseous exhaust stream comprising hydrocarbons, carbon monoxide, and nitrogen oxide.

Aspects of the presently claimed invention are more fully illustrated by the following examples, which are set forth to illustrate certain aspects of the present invention and are not to be construed as limiting thereof.

### Example 1: Comparative Catalytic Article A

Comparative catalytic article A is a zoned bilayer Pt/Pd/Rh catalytic article with a PGM loading of 120 g/ft³ (Pt/Pd/Rh=58/58/4) coated onto a cylindrical monolith cordierite substrate having dimensions of 4.66″ in diameter and 3.81″ in length, a cell density of 800 cpsi, and a wall thickness of 3 mils.

Inlet Zone of Bottom Layer: This zone covers 50% of the substrate length from an inlet to middle with a PGM loading of 104.4 g/ft³ (Pt/Pd/Rh=0/104.4/0). A slurry containing about 25.4 wt. % of the alumina, 62.5 wt. % of the stabilized ceria-zirconia mixed oxide (OSC with ˜40 wt. % ceria), barium acetate to yield 7.8 wt. % of BaO, zirconium acetate to yield 2.0 wt. % of ZrO₂, and palladium nitrate to yield 2.36 wt. % of Pd was coated onto the substrate. The washcoat loading of the inlet zone of the bottom layer was about 2.56 g/in³ after calcination at 550° C. for 1 hour in air.

Outlet Zone of Bottom Layer: This zone covers 50% of the substrate length from outlet to middle with a PGM loading of 127.6 g/ft³ (Pt/Pd/Rh=116/11.6/0). A slurry containing about 33.0 wt. % of the ceria-alumina composite with approximately 8 wt. % ceria, 54.4 wt. % of the stabilized ceria-zirconia mixed oxide (OSC with ˜40 wt. % ceria), barium acetate to yield 7.8 wt. % of BaO, a colloidal alumina binder to yield 1.9 wt. % of Al₂O₃, a platinum-amine complex to yield 2.61 wt. % of Pt, and palladium nitrate to yield 0.26 wt. % of Pd was coated onto the substrate. The washcoat loading of the outlet zone of the bottom layer was about 2.57 g/in³ after calcination at 550° C. for 1 hour in air.

Top Layer: This layer covers 100% of the substrate length with a PGM loading of 4 g/ft³ (Pt/Pd/Rh=0/0/4). A slurry mixture containing about 84.8 wt. % of the ceria-alumina composite with ˜8 wt. % ceria, 15.0 wt. % of a ceria-zirconia composite (binder) with approximately 50 wt. % ceria, and rhodium nitrate to yield 0.23 wt. % of Rh was coated over the bottom layer. The washcoat loading of the top layer was about 1.00 g/in³ after calcination at 550° C. for 1 hour in air.

### Example 2: Comparative Catalytic Article B

Comparative catalytic article B is a zoned bilayer Pt/Pd/Rh catalytic article with a PGM loading of 120 g/ft³ (Pt/Pd/Rh=29/87/4) coated onto a cylindrical monolith cordierite substrate having dimensions of 4.66″ in diameter and 3.81″ in length, a cell density of 800 cpsi, and a wall thickness of 3 mils.

Inlet Zone of Bottom Layer: This zone covers 50% of the substrate length from inlet to middle with a PGM loading of 156.6 g/ft³ (Pt/Pd/Rh=0/156.6/0). A slurry containing about 25.1 wt. % of the alumina, 61.8 wt. % of the stabilized ceria-zirconia mixed oxide (OSC with ˜40 wt. % ceria), barium acetate to yield 7.7 wt. % of BaO, zirconium acetate to yield 1.9 wt. % of ZrO₂, and palladium nitrate to yield 3.50 wt. % of Pd was coated onto the substrate. The washcoat loading of the inlet zoned of the bottom layer was about 2.59 g/in³ after calcination at 550° C. for 1 hour in air.

Outlet Zone of Bottom Layer: This zone covers 50% of the substrate length from outlet to middle with a PGM loading of 75.4 g/ft³ (Pt/Pd/Rh=58/17.4/0). A slurry containing about 33.4 wt. % of the ceria-alumina composite with ˜8 wt. % ceria, 55.0 wt. % of the stabilized ceria-zirconia mixed oxide (OSC with ˜ 40 wt. % ceria), barium acetate to yield 7.9 wt. % of BaO, a colloidal alumina binder to yield 2.0 wt. % of Al₂O₃, a platinum-amine complex to yield 1.32 wt. % of Pt, and palladium nitrate to yield 0.40 wt. % of Pd was coated onto the substrate. The washcoat loading of the outlet zone of the bottom layer was about 2.54 g/in³ after calcination at 550° C. for 1 hour in air.

Top Layer: Same as top layer of example 1.

### Example 3: Comparative Catalytic Article C

Comparative catalytic article C is a zoned single layer Pt/Pd/Rh catalytic article with a PGM loading of 104 g/ft3 (Pt/Pd/Rh=0/100/4) coated onto a cylindrical monolith cordierite substrate having dimensions of 4.66″ in diameter and 3.81″ in length, a cell density of 800 cpsi, and a wall thickness of 3 mils.

Inlet Zone: This zone covers 50% of the substrate length from inlet to middle with a PGM loading of 200 g/ft³ (Pt/Pd/Rh=0/200/0). A slurry containing about 31.2 wt. % of the refractory alumina, 54.6 wt. % of the stabilized ceria-zirconia mixed oxide (OSC with ˜40 wt. % ceria), barium acetate to yield 7.8 wt. % of BaO, zirconium acetate to yield 1.9 wt. % of ZrO₂, and palladium nitrate to yield 4.51 wt. % of Pd was coated onto the substrate. The washcoat loading of the inlet zone was about 2.57 g/in³ after calcination at 550° C. for 1 hour in air.

Outlet Zone: This zone covers 50% of the substrate length from outlet to middle with a PGM loading of 8 g/ft³ (Pt/Pd/Rh=0/0/8). A slurry containing about 39.0 wt. % of the ceria-alumina composite with ˜8 wt. % ceria, 54.6 wt. % of the stabilized ceria-zirconia mixed oxide (OSC with ˜40 wt. % ceria), 3.9 wt. % of BaSO₄, a colloidal alumina binder to yield 0.4 wt. % of Al₂O₃, zirconium acetate to yield 1.9 wt. % of ZrO₂, rhodium nitrate to yield 0.18 wt. % of Rh was coated onto the substrate. The washcoat loading of the outlet zone was about 2.56 g/in³ after calcination at 550° C. for 1 hour in air.

### Example 4: Inventive Catalytic Article D

Invention catalytic article D is a zoned single layer Pt/Pd/Rh catalytic article with a PGM loading of 120 g/ft³ (Pt/Pd/Rh=29/87/4) coated onto a cylindrical monolith cordierite substrate having dimensions of 4.66″ in diameter and 3.81″ in length, a cell density of 800 cpsi, and a wall thickness of 3 mils.

Inlet Zone: This zone covers 50% of the substrate length from inlet to middle with a PGM loading of 64 g/ft³ (Pt/Pd/Rh=58/0/6). A slurry containing about 35.3 wt. % of the ceria-alumina composite with ˜8 wt. % ceria, 56.9 wt. % of the stabilized ceria-zirconia mixed oxide (OSC with ˜40 wt. % ceria), 3.9 wt. % of BaSO₄, a colloidal alumina binder to yield 0.4 wt. % of Al₂O₃, zirconium acetate to yield 2.0 wt. % of ZrO₂, rhodium nitrate to yield 0.14 wt. % of Rh, and a platinum-amine complex to yield 1.32 wt. % of Pt was coated onto the substrate. The washcoat loading of the inlet zone was about 2.55 g/in³ after calcination at 550° C. for 1 hour in air.

Outlet Zone: This zone covers 50% of the substrate length from outlet to middle with a PGM loading of 176 g/ft³ (Pt/Pd/Rh=0/174/2). A slurry containing about 31.3 wt. % of the refractory alumina, 54.9 wt. % of the stabilized ceria-zirconia mixed oxide (OSC with ˜40 wt. % ceria), barium acetate to yield 7.8 wt. % of BaO, zirconium acetate to yield 2.0 wt. % of ZrO₂, rhodium nitrate to yield 0.05 wt. % of Rh, and palladium nitrate to yield 3.95 wt. % of Pd was coated onto the substrate. The washcoat loading of the outlet zone was about 2.55 g/in³ after calcination at 550°° C. for 1 hour in air.

### Example 5: Inventive Catalytic Article E

Invention catalytic article E is a zoned Pt/Pd/Rh catalytic article with a PGM loading of 120 g/ft³ (Pt/Pd/Rh=58/58/4) coated onto a cylindrical monolith cordierite substrate having dimensions of 4.66″ in diameter and 3.81″ in length, a cell density of 800 cpsi, and a wall thickness of 3 mils.

Inlet Zone: This zone covers 50% of the substrate length from inlet to middle with a PGM loading of 143 g/ft³ (Pt/Pd/Rh=108/29/6). A slurry containing about 42.3 wt. % of the ceria-alumina composite with ˜8 wt. % ceria, 50.2 wt. % of the stabilized ceria-zirconia mixed oxide (OSC with ˜40 wt. % ceria), 3.1 wt. % of BaSO₄, a colloidal alumina binder to yield 0.3 wt. % of Al²O³, zirconium acetate to yield 1.6 wt. % of ZrO², rhodium nitrate to yield 0.11 wt. % of Rh, palladium nitrate to yield 0.53 wt. % of Pd, and a platinum-amine complex to yield 1.96 wt. % of Pt was coated onto the substrate. The washcoat loading of the inlet zone was about 3.19 g/in³ after calcination at 550° C. for 1 hour in air.

Outlet Zone: This zone covers 50% of the substrate length from outlet to middle with a PGM loading of 97 g/ft³ (Pt/Pd/Rh=8/87/2). A slurry containing about 19.2 wt. % of the alumina, 15.3 wt. % of the refractory ceria-alumina composite with ˜8 wt. % ceria, 53.6 wt. % of the stabilized ceria-zirconia mixed oxide (OSC with ˜40 wt. % ceria), barium acetate to yield 7.7 wt. % of BaO, zirconium acetate to yield 1.9 wt. % of ZrO₂, rhodium nitrate to yield 0.05 wt. % of Rh, a platinum-amine complex to yield 0.18 wt. % of Pt, and palladium nitrate to yield 1.93 wt. % of Pd was coated onto the substrate. The washcoat loading of the outlet zone was about 2.61 g/in³ after calcination at 550° C. for 1 hour in air.

### Example 6: Inventive Catalytic Article F

Invention catalytic article F is a zoned Pt/Pd/Rh catalytic article with a PGM loading of 120 g/ft³ (Pt/Pd/Rh=29/87/4) coated onto a cylindrical monolith cordierite substrate having dimensions of 4.66″ in diameter and 3.81″ in length, a cell density of 800 cpsi, and a wall thickness of 3 mils.

Bottom Layer of Inlet Zone: This zone covers 50% of the substrate length from inlet to middle with a PGM loading of 90 g/ft³ (Pt/Pd/Rh=58/26/6). A slurry containing about 35.1 wt. % of the ceria-alumina composite with ˜8 wt. % ceria, 56.6 wt. % of the stabilized ceria-zirconia mixed oxide (OSC with ˜40 wt. % ceria), 3.9 wt. % of BaSO₄, a colloidal alumina binder to yield 0.4 wt. % of Al₂O₃, zirconium acetate to yield 2.0 wt. % of ZrO₂, rhodium nitrate to yield 0.14 wt. % of Rh, palladium nitrate to yield 0.59 wt. % of Pd, and a platinum-amine complex to yield 1.31 wt. % of Pt was coated onto the substrate. The washcoat loading of the inlet zone was about 2.56 g/in³ after calcination at 550° C. for 1 hour in air.

Top Layer of Inlet Zone: This zone covers 31.5% of the substrate length from inlet to middle. A slurry containing about 95.3 wt. % of a barium doped alumina and a colloidal alumina binder to yield 4.7 wt. % of Al₂O₃ was coated over the bottom layer. The washcoat loading of the top layer of inlet zone divided by substrate volume coated by the top layer of inlet zone was about 0.75 g/in³ after calcination at 550° C. for 1 hour in air.

Outlet Zone: This zone covers 50% of the substrate length from outlet to middle with a PGM loading of 150 g/ft³ (Pt/Pd/Rh=0/148/2). A slurry containing about 31.5 wt. % of the refractory alumina, 55.2 wt. % of the stabilized ceria-zirconia mixed oxide (OSC with ˜ 40 wt. % ceria), barium acetate to yield 7.9 wt. % of BaO, zirconium acetate to yield 2.0 wt. % of ZrO₂, rhodium nitrate to yield 0.05 wt. % of Rh, and palladium nitrate to yield 3.37 wt. % of Pd was coated onto the substrate. The washcoat loading of the outlet zone was about 2.54 g/in3 after calcination at 550° C. for 1 hour in air.

### Example 7: Catalytic Article G

Catalytic article G is a single layer Pt/Rh catalytic article with a PGM loading of 12 g/ft³ (Pt/Pd/Rh=10/0/2) coated onto a cylindrical monolith cordierite substrate having dimensions of 5.2″ in diameter and 3.96″ in length, a cell density of 400 cpsi, and a wall thickness of 6.5 mils.

A slurry containing about 50.8 wt. % of ceria-alumina composite with ˜8 wt. % ceria, 43.5 wt. % of the stabilized ceria-zirconia mixed oxide (OSC with ˜40 wt. % ceria), barium acetate to yield 3.6 wt. % of BaO, zirconium acetate to yield 1.1 wt. % of ZrO₂, a colloidal alumina binder to yield 0.7 wt. % of Al₂O₃, a platinum-amine complex to yield 0.21 wt. % of Pt, and rhodium nitrate to yield 0.04 wt. % of Rh was coated onto the substrate. The washcoat loading was about 2.76 g/in³ after calcination at 550° C. for 1 hour in air.

### Example 8: Aging and Testing of Catalytic Articles

Catalytic articles were aged using a 4-mode exothermic aging protocol with effective catalyst temperature of 877° C. for 60 hours with phosphorus doped fuel on an engine setup. Catalytic article A-F was mounted on close coupled front location, while catalytic article G was mounted on close coupled rear location. The engine-out gas feed composition alternates between rich and lean to simulate typical vehicle operating conditions.

The emission performance was tested using a 2.7 L ULEV50 vehicle with a close coupled tandem (front close coupled catalyst (CCC1)/rear close coupled catalyst (CCC2)) emissions control system configuration operating under the FTP-75 test protocol. Catalyst A, B, C, D, E and F were tested as CCC1 catalyst, while catalyst G was used as a common CCC2 catalyst.

During cold start portion of FTP-75 test, the close coupled catalyst is warmed up by the heat it receives from the engine exhaust.

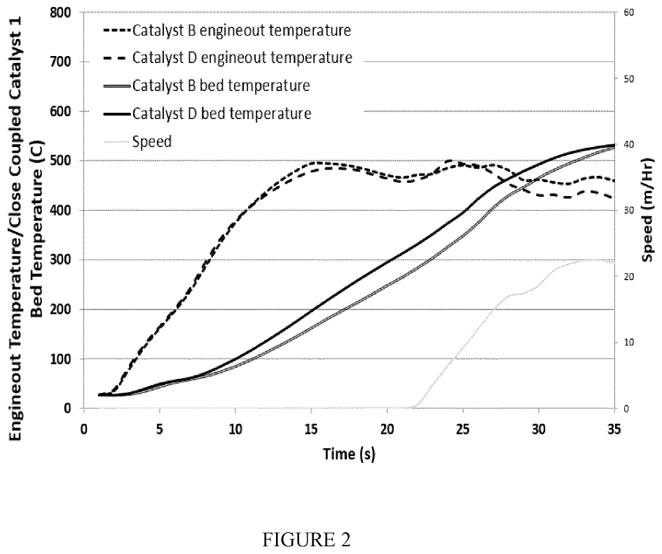

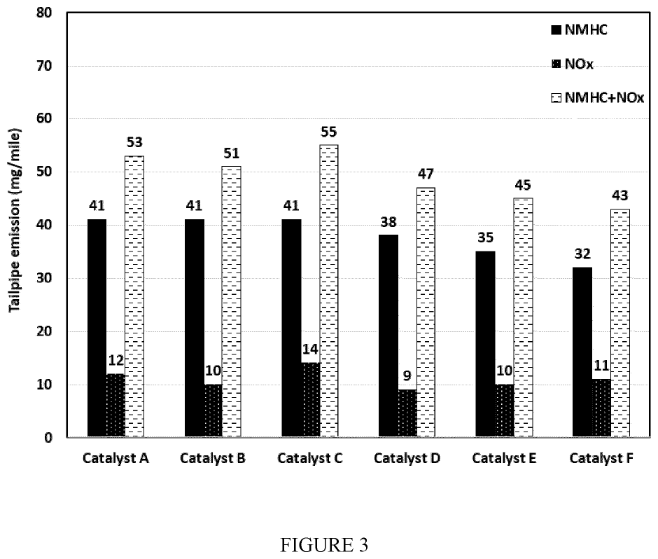

FIG. 2 shows that catalyst D warmed up faster than the catalyst B likely due to lower wash coat loading. Faster warmup is beneficial during cold start as catalytic activity is kinetic driven. The advantage of inventive catalytic articles is demonstrated in FIG. 3. The inventive catalyst D and F have lower tailpipe emissions than the comparative catalyst B and C when tested as CCC1. Comparative catalyst C has similar wash coat loading as inventive catalyst D, indicating performance advantage of inventive catalyst D over comparative catalyst C is due to catalyst design (such as wash coat design and PGM loading/ratio) rather than lower wash coat loading. It is observed that the comparative catalyst C shows highest NOx emission probably because the front zone doesn't contain Rh. The results suggest that Rh needs to be distributed throughout the catalyst to ensure good NOx performance. Comparative catalyst B and inventive catalyst D have same PGM loading/ratio, indicating the improvement of inventive catalyst D is due to wash coat design. Emission performance of inventive catalyst F is further improved by providing an overcoat free from PGM which protects wash coat layer underneath from phosphorus poisoning.

The inventive catalyst E shows lower tailpipe emissions than the comparative catalyst A when tested as CCC1. Catalyst E and catalyst A have same PGM loading/ratio, indicating the improvement is due to wash coat design.

Although the embodiments disclosed herein have been described with reference to particular embodiments it is to be understood that these embodiments are merely illustrative of the principles and applications of the presently claimed invention. It will be apparent to those skilled in the art that various modifications and variations can be made to the methods and apparatus of the presently claimed invention without departing from the spirit and scope of the presently claimed invention. Thus, it is intended that the presently claimed invention include modifications and variations that are within the scope of the appended claims and their equivalents, and the above-described embodiments are presented for purposes of illustration and not of limitation.

1. A catalytic article comprising:
a) a substrate;
b) a first zone coated with a first catalytic layer; and
c) a second zone coated with a second catalytic layer,
wherein the first catalytic layer comprises platinum supported on ceria-zirconia mixed oxide or ceria-alumina composite or both; and rhodium supported on ceria-zirconia mixed oxide, ceria-alumina composite, alumina or any combination thereof,
wherein the second catalytic layer comprises palladium supported on ceria-zirconia mixed oxide, alumina, ceria alumina composite or any combination thereof; and rhodium supported on ceria-zirconia mixed oxide, alumina, ceria alumina composite or any combination thereof,
wherein the first zone occupies a flow-in end portion of the substrate and the second zone occupies a flow-out end portion of the substrate.

2. The catalytic article according to claim 1, wherein the first catalytic layer further comprises palladium supported on ceria-zirconia mixed oxide or ceria-alumina composite or both.

3. The catalytic article according to claim 1, wherein the second catalytic layer further comprises platinum supported on ceria-zirconia mixed oxide, alumina, ceria-alumina composite or any combination thereof.

4. The catalytic article according to claim 1, wherein a total loading of the first catalytic layer and the second catalytic layer divided by substrate volume is less than 3.2 gram per cubic inch.

5. The catalytic article according to claim 1,
wherein the amount of platinum in the first catalytic layer and the second catalytic layer is in the range of 0.02 to 3.0 wt. %, based on the total weight of the first catalytic layer and the second catalytic layer,
wherein the amount of palladium in the first catalytic layer and the second catalytic layer is in the range of 0.02 to 5.0 wt. %, based on the total weight of the first catalytic layer and the second catalytic layer, and
wherein the amount of rhodium in the first catalytic layer and the second catalytic layer is in the range of 0.01 to 1.0 wt. %, based on the total weight of the first catalytic layer and the second catalytic layer.

6. The catalytic article according to claim 1,
wherein the total amount of platinum supported on ceria-zirconia mixed oxide or ceriaalumina composite or both in the first catalytic layer is 80 to 100 wt. %, based on the total weight of platinum in the first and the second catalytic layer,
wherein the total amount of palladium supported on ceria-zirconia mixed oxide, alumina, ceria-alumina composite or any combination thereof in the second catalytic layer is 75 to 100 wt. %, based on the total weight of palladium in the first catalytic layer and the second catalytic layer, and
wherein the weight proportion rhodium supported on ceria-zirconia mixed oxide or ceria-alumina composite or both in the first catalytic layer to rhodium supported on ceria-zirconia mixed oxide, alumina, ceria-alumina composite or any combination thereof in the second catalytic layer is in the range of 1.5:1 to 4:1.

7. The catalytic article according to claim 1, wherein the first zone further comprises an overcoat deposited at least on a part of the first zone, wherein the overcoat comprises a porous refractory oxide, and optionally, at least one base metal oxide.

8. The catalytic article according to claim 7, wherein the overcoat is essentially free of precious metal/s and optionally, comprises an oxygen storage component.

9. The catalytic article according to claim 7, wherein the length of the overcoat is equal or less than 50% of total length of the substrate.

10. The catalytic article according to claim 7, wherein a loading of the overcoat divided by substrate volume coated by the overcoat is less than 1 gram per cubic inch.

11. The catalytic article according to claim 7, wherein the porous refractory oxide is stabilized or non-stabilized aluminum oxide.

12. The catalytic article according to claim 7, wherein the base metal oxide is an alkaline earth metal oxide or a rare earth metal oxide,
wherein the alkaline earth metal oxide is selected from barium oxide, magnesium oxide, calcium oxide, strontium oxide, or a combination thereof,
wherein the rare earth metal oxide is at least one oxide of a rare earth metal selected from Ce, Pr, Nd, Eu, Sm, Yb, and La, or a mixture thereof.

13. The catalytic article according to claim 1,
wherein the first zone covers 40 to 60% of the entire substrate length from the flow-in end portion,
wherein the second zone covers 60 to 40% of the entire substrate length from the flow-out end portion.

14. (canceled)

15. The catalytic article according to claim 1, wherein the amount of the ceria-zirconia mixed oxide present in the first catalytic layer and the second catalytic layer is 40 to 60 wt. %, based on the total weight of the first catalytic layer and the second catalytic layer.

16. The catalytic article according to claim 1, wherein the amount of the alumina present in the first catalytic layer and the second catalytic layer is in the range of 5.0 to 20 wt. %, based on the total weight of the first catalytic layer and the second catalytic layer.

17. The catalytic article according to claim 1
wherein the alumina is selected from alumina, lanthana-alumina, titania-alumina, ceria-zirconia-alumina, zirconia-alumina, ceria-alumina, lanthana-zirconia-alumina, baria-alumina, baria-lanthana-alumina, baria-lanthana-neodymia-alumina, or any combination thereof.

18-22. (canceled)

23. The catalytic article according claim 1, wherein the substrate is selected from a ceramic substrate, a metal substrate, a ceramic foam substrate, a polymer foam substrate, or a woven fiber substrate.

24. A process for the preparation of the catalytic article according to claim 1, wherein said process comprises:
preparing a first catalytic layer slurry comprising platinum supported on ceria-zirconia mixed oxide or ceria-alumina composite or both; and rhodium supported on ceria-zirconia mixed oxide or ceria-alumina composite or both;
-preparing a second catalytic layer slurry comprising palladium supported on ceria-zirconia mixed oxide, alumina, ceria-alumina composite or any combination thereof; and rhodium supported on ceria-zirconia mixed oxide, alumina, ceria-alumina composite or combination thereof;
coating the first catalytic layer slurry on the flow-in end portion of the substrate to obtain a first zone;
coating the second catalytic layer slurry on the flow-out end portion of the substrate to obtain a second zone;
subjecting the substrate to calcination at a temperature ranging from 400 to 700° C.,
wherein the step of preparing the slurry comprises a technique selected from incipient wetness impregnation, incipient wetness co-impregnation, and post-addition.

25. An exhaust gas treatment system for internal combustion engines, said system comprising the catalytic article according to claim 1.

26. A method of treating a gaseous exhaust stream comprising hydrocarbons, carbon monoxide, and nitrogen oxide, the method comprising contacting said exhaust stream with the catalytic article according to claim 1.

27-28. (canceled)
